(19) United States
(12) Patent Application Publication
(10) Pub. No.: US 2007/0140281 A1
(43) Pub. Date: Jun. 21, 2007

(54) Network communication apparatus with shared buffers

(75) Inventors: Min-Hung Chan, Shulin City (TW); Yao-Yu Hsieh, Taoyuan City (TW)

Correspondence Address: HOGAN & HARTSON L.L.P., 1999 AVENUE OF THE STARS, SUITE 1400, LOS ANGELES, CA, 90067, US

(73) Assignee: Elite Silicon Technology, Inc.

(21) Appl. No.: 11/305,566

(22) Filed: Dec. 16, 2005

(51) Int. Cl. H04L 12/56

(52) U.S. Cl. 370/412

(57) ABSTRACT

An apparatus for network communication comprises a plurality of hardware sockets and a plurality of buffers shared by hardware sockets to store information received from and to be transmitted to the network. The buffer is capable of storing one data unit transferred on the network. The hardware socket is capable of locking and releasing the buffers to allow buffer sharing. The number of the buffers is less than the number of the hardware sockets.

### BACKGROUND

1. Field of the Invention

The present invention relates to network communication. More specifically, the present invention relates to an apparatus and a method for network communication using hardware sockets that share buffer space.

2. Description of the Related Art

Each network communication apparatus contains a combination of hardware and software that translates protocols and processes data. A network communication apparatus normally implements the Physical Layer and Link Layer Protocols in hardware, and implements the higher protocols, including Network Layer, Transport Layer, and Application Layer Protocols, in software. An example is the network communication apparatus used by a printer server attached to a network system. The software programs handling the Network Layer and Transport Layer Protocols are sockets used as endpoints for sending and receiving data between processes or application programs. When the network system uses transmission control protocol/internet protocol (TCP/IP) for communication, the transmission control protocol is the Transport Layer Protocol and the internet protocol is the Network Layer Protocol.

As mentioned above, a socket, conventionally, is a software object that connects an application program to a network protocol in UNIX and some other operating systems. In UNIX, for example, a program can send and receive TCP/IP messages by opening a socket and then reading data from and writing data to the socket. This simplifies program development because a programmer need only worry about manipulating the socket and can rely on the operating system to actually transport messages across the network correctly.

However, when the amount of information transferred on the network substantially increases, software sockets slow down the speed of network communication due to the complicated calculation. To increase the efficiency and reduce CPU burden, a hardware socket can be implemented by logic circuits to perform functions of Network Layer and Transport Layer Protocols conventionally done by a software socket, such as listening, sending, connecting and binding. One example is the WIZnet W3150A chip manufactured by WIZnet Co., Inc., which implements the hardware TCP/IP protocol stack in full hardwired logic.

Typically, a network communication apparatus transmits data in a standardized format, such as packets, TCP/IP datagrams, frames, or ATM cells, which generally are referred to as data units. Each data unit generally includes a header portion with addressing information and a body portion with transmitted data. A data unit sent between network communication apparatuses may vary in size depending on the type of the data unit. When a data unit arrives at a socket of a network communication apparatus, a routing algorithm analyzes the header and makes a forwarding decision based on a destination address carried by the header.

A network communication apparatus can send data to and receive data from another apparatus through network. A network communication apparatus has sockets to establish connections with other apparatus to send and receive data. In the process of transferring data from and to the network, sockets need to use buffers (memories) for data storage. A buffer can be a data storage device or a range of memory space in a data storage device. For example, data received from the network is stored in a buffer and then transferred to a destination internally. Data to be transmitted to the network is also stored in a buffer before transmission. A network communication apparatus decides if an incoming data unit is buffered or dropped.

Traditionally, each socket has a dedicated buffer for data storage. For example, a network communication apparatus with 10 sockets has 10 buffers. As a result, the buffer memories usually occupy tremendous size in a network communication apparatus.

### SUMMARY OF THE PREFERRED EMBODIMENTS

An apparatus for network communication comprises a plurality of hardware sockets and a plurality of buffers shared by hardware sockets to store information received from and to be transmitted to the network. The buffer is capable of storing one data unit transferred on the network. The hardware socket is capable of locking and releasing the buffers to allow buffer sharing. The number of the buffers is less than the number of the hardware sockets.

### BRIEF DESCRIPTION OF THE DRAWINGS

A more complete understanding of the present invention can be obtained by reference to the detailed description in conjunction with the accompanying drawings, which form part of the disclosure. These drawings depict only a typical embodiment of the invention and are not intended to limit its scope.

FIG. 1 is a schematic diagram of an exemplary embodiment of the apparatus for network communication.

FIG. 2 is a schematic diagram of the network engine shown in FIG. 1.

FIG. 3 is a schematic diagram of the hardware socket shown in FIG. 2.

FIG. 4 is a flow chart diagram of an exemplary embodiment of receiving buffer management.

FIG. 5 is a flow chart diagram of an exemplary embodiment of transmitting buffer management.

### DETAILED DESCRIPTION OF THE PREFERRED EMBODIMENTS

A network communication apparatus that shares buffers between hardware sockets can be made smaller than a conventional configuration of a network communication apparatus. A buffer, which is necessary for a hardware socket to receive information from network and to transmit information to network, can be a data storage device or a range of memory space in a data storage device. However, buffers usually occupy tremendous size of the network communication apparatus. Because it is rare that all hardware sockets are receiving information or transmitting information at the same time, each hardware socket need not have a dedicated buffer. That is to say, a plurality of hardware sockets can share fewer of buffers. As a result, the size of a network communication apparatus can be made smaller.

The hardware socket can lock and release buffers to allow buffer sharing. To carry out this function, the hardware socket which is using a buffer sets the value of a corresponding index or pointer in the apparatus to lock the buffer. After the stored information is processed, the hardware socket resets the value of the corresponding index or pointer to release the buffer. The value of an index or pointer can indicate the availability of the corresponding buffer.

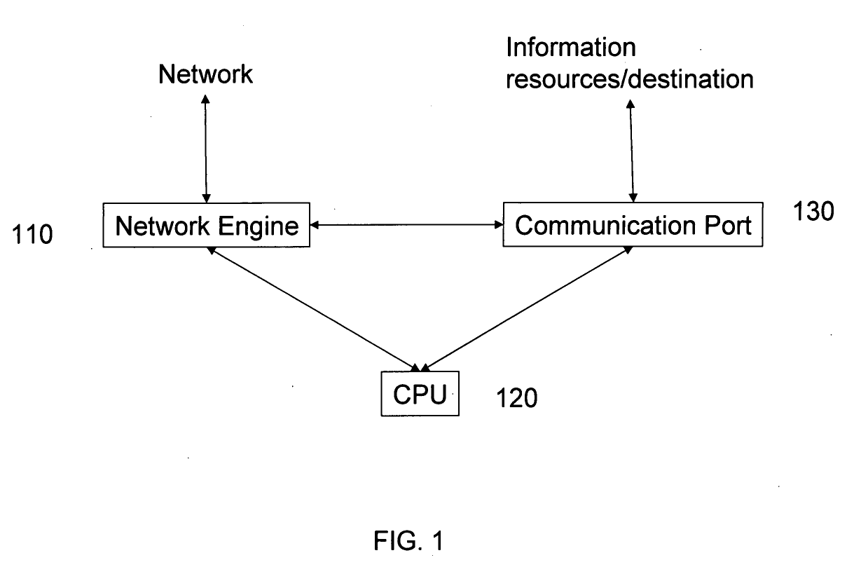

As shown in FIG. 1, a network communication apparatus includes a network engine 110, a CPU 120, and a communication port 130. The network engine 110 receives information from and transmits information to network. The CPU 120 is driven by firmware to achieve designed functions and to execute user's instructions. Depending on the usage of the network communication apparatus, the CPU 120 can be an 8-bit CPU or a 16-bit CPU. On one hand, the communication port 130 transfers information received by the network engine to its destination, such as the USB port of a printer or a host computer. On the other hand, the communication port 130 also transfers information from its source, such as a temperature sensor, to the network engine 110 for transmission out to network.

The apparatus can be used for intranet and internet communication. In addition, the apparatus can be designed to communicate with the network through various different protocols. In one embodiment, the apparatus is used to communicate with the intranet through the transmission control protocol/internet protocol (TCP/IP).

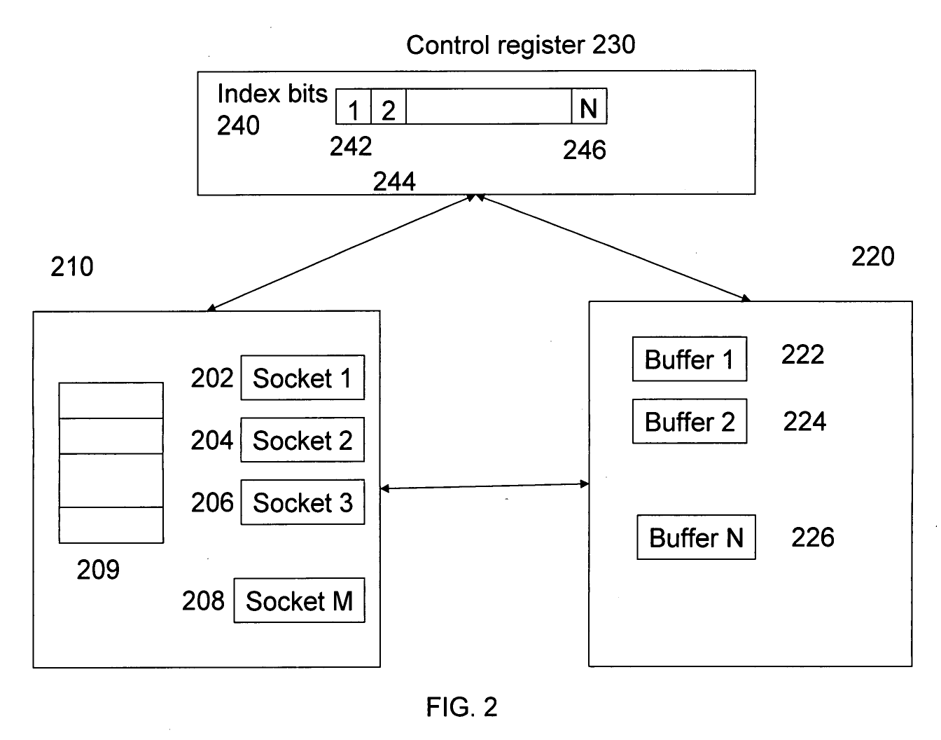

FIG. 2 is a schematic diagram of the internal structure of the network engine 110. The network engine 110 includes a plurality of hardware sockets from socket 1 (202), socket 2 (204), socket 3 (206) to socket M (208), a plurality of buffers from buffer 1 (222), buffer 2 (224), to buffer N (226), and a control register 230. A buffer can be a data storage device or a range of memory space in a data storage device. The number N of buffers is less than the number M of hardware sockets. In other words, more hardware sockets can share less buffers. In addition, each hardware socket can use each buffer as long as the buffer is available.

The control register 230 contains a plurality of index bits from index bit 1 (242), index bit 2 (244), to index bit N (246) to indicate the availability of corresponding buffers. For example, buffer 1 (222) is available when the value of index bit 1 (242) is one. Buffer 1 (222) is not available when the value of index bit 1 (242) is zero. A skilled artisan will appreciate other ways to indicate the availability of buffers, such as using pointers. In one embodiment, the hardware sockets, the buffers, and the control register are manufactured in a single chip to reduce the size and improve the performance.

Information transferred on the network is usually divided into small data units. The data units from the network are first received by and stored in buffers. Each buffer is a memory space capable of storing one data unit transferred on the network. When the network communication adopts TCP/IP, each buffer is capable of storing one packet of information which has 1536 bytes.

All hardware sockets monitor the same received information concurrently. Once a hardware socket determines that a data unit stored in a specific buffer belongs to itself, the hardware socket sets the value of a corresponding index bit in the control register 230 to lock the buffer. After the data unit is processed, the hardware socket resets the value of the index bit to release the buffer so that other hardware sockets can use it. A plurality of registers 209 receive the same information concurrently received by a buffer. The registers 209 may or may not be accessed by the CPU. In order to monitor the received information, each hardware socket connects to the registers 209 to determine whether the received data unit belongs to itself.

In one embodiment, the network engine 110 includes eight hardware sockets, five buffers and five index bits. Eight hardware sockets share five buffers. The hardware socket can perform all functions in the TCP and IP layers, including checking the relationship of adjacent packets. The buffers are located in an 8 Kbytes SRAM. Each buffer has 1536 bytes of memory space in the SRAM. A skilled artisan would appreciate various other ways to configure buffers.

Three registers 209 are connected to eight hardware sockets so that they can monitor the received information concurrently. In one embodiment using a 32-bit data bus, each register can store 32 bits each of which is implemented by a flip-flop. The network engine checks a received packet for errors while writing the packet to a buffer. This check can be done within 20 clock cycles after the network engine receives the last bit of the packet from the network bus. For example, in a 60 MHz system, the error check takes only about 0.3 μs.

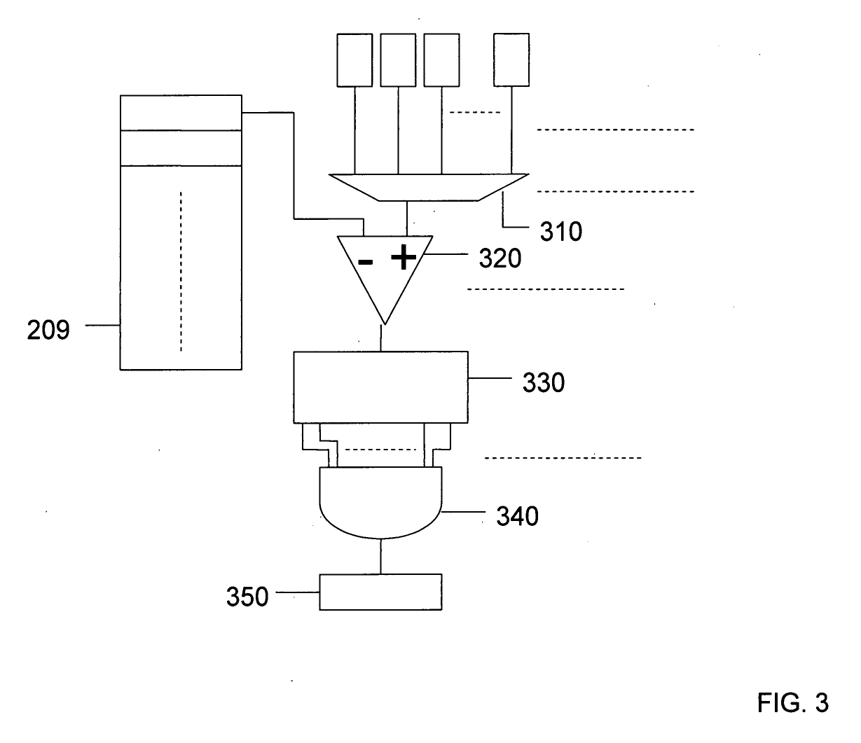

As shown in FIG. 3, the hardware socket comprises a multiplexer 310, a comparator 320, a condition signal latch 330, an AND gate 340 and a control signal latch 350 to determine whether a data unit stored in a specific buffer belongs to a hardware socket. While buffer 1 (222) is receiving an incoming data unit, it transfers data to the registers 209 at the same time. The output of the registers connects to the first input of the comparator 320 of each hardware socket. The multiplexer 310 selects appropriate recognition information such as TCP and IP header information and outputs it to the second input of the comparator 320. The TCP header information includes source port, destination port, sequence number, acknowledgement number, checksum and urgent pointer. The IP header information includes total length, identification, flags, fragment offset, header checksum, source address and destination address. The comparator 320 sequentially compares header information in the received data unit with selected recognition information. If the data stored in a register matches the selected recognition information, the comparator 320 outputs a one, as a condition signal, to the AND gate 340 through the condition signal latch 330. If the data stored in a register does not match the selected recognition information, the comparator 320 outputs a zero, as a condition signal, to the AND gate 340 through the condition signal latch 330.

All recognition information, such as the total length, identification, header checksum, source address, and destination address, is compared sequentially to collectively determine whether a data unit belongs to a specific hardware socket. If all recognition information matches, all condition signals input to the AND gate 340 are ones and the output of the AND gate is one. When the output of the AND gate is one, the hardware socket determines the current data unit belongs to itself. If any of the recognition information is not matched, at least one condition signal input to the AND gate 340 is zero and the output of the AND gate is zero. When the output of the AND gate is zero, the hardware socket concludes the current data unit does not belong to itself. At the time all recognition information is compared, the output of the AND gate 340 is then latched in the control signal latch 350. If all conditions are met, the control signal latch 350 outputs a signal to lock the buffer and to set the value of the corresponding index bit.

Some of the buffers Rx are configured to store information received from the network and the other buffers Tx are configured to store information to be transmitted to the network. Depending on the application of the apparatus, the number of receiving buffers can be adjusted. For example, when the apparatus is used in a network printer server which mostly receives information, the CPU firmware can allocate four buffers for receiving information and one buffer for transmitting information. When the apparatus is used in a temperature sensor device which mostly transmits information, the CPU firmware can allocate four buffers for transmitting information and one buffer for receiving information.

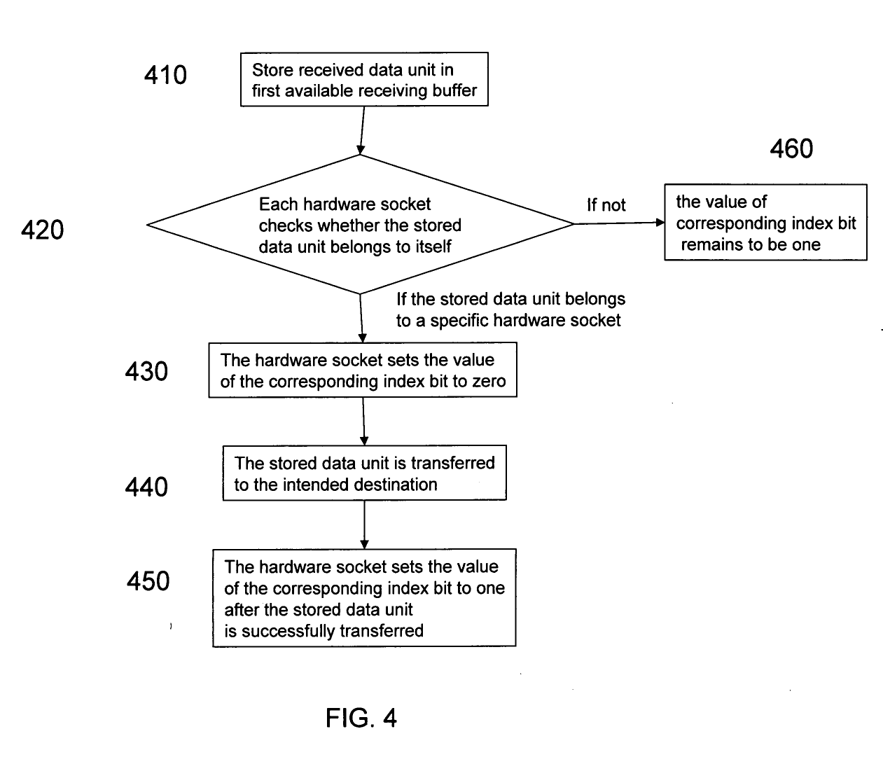

FIG. 4 shows a process flow of buffer allocation for receiving buffers. At step 410, a first data unit (a packet in TCP/IP) of the received information is stored in a first available receiving buffer. At step 420, each hardware socket checks whether the stored data unit belongs to itself. If the stored data unit belongs to a specific hardware socket, at step 430, that hardware socket sets the value of the index bit corresponding to the first available receiving buffer to zero (0). When the value of an index bit for a receiving buffer is set to zero (0), the receiving buffer is locked and no longer available for storing other data units received later. At step 440, the stored data unit is processed by transferring to an intended destination, such as a USB port of a network printer server, through the communication port 130. At step 450, after the stored data unit is successfully transferred, the hardware socket sets the value of the corresponding index bit to one (1). When the value of an index bit is set to one (1), the corresponding buffer is released and is again available for storing other data units received later. At step 460, if the stored data unit does not belong to any hardware socket, the data unit is dropped and the value of the index bit corresponding to the first available buffer remains to be one (1). And the next coming data unit will be stored in the same buffer.

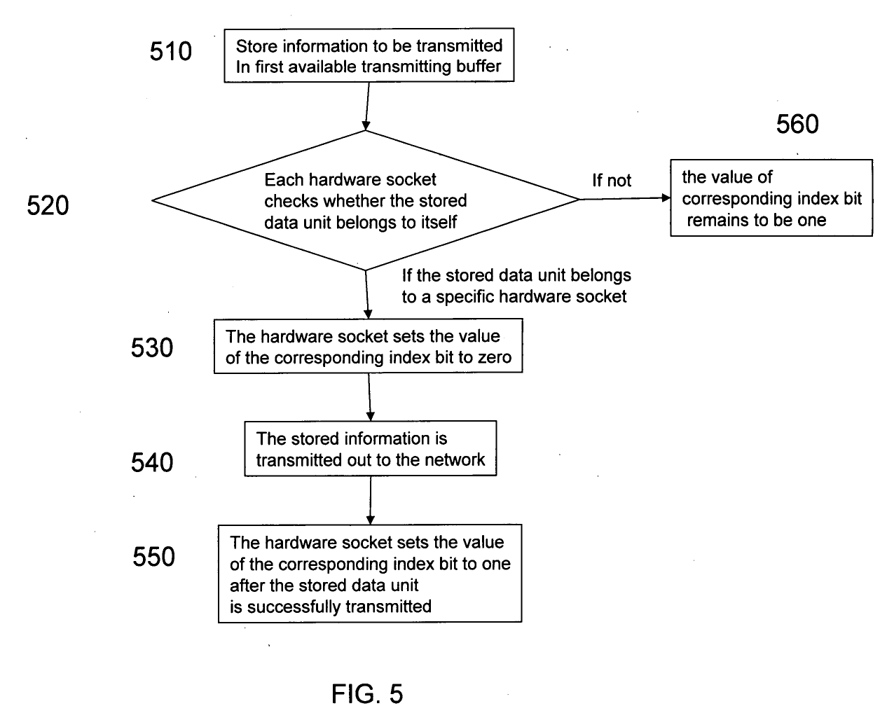

FIG. 5 shows a process flow of buffer allocation for transmitting buffers. At step 510, information to be transmitted out to the network is stored in a first available transmitting buffer. In general, the outgoing information in the format of data units (packets in TCP/IP) is from the communication port 130. At step 520, each hardware socket checks whether the data unit stored in the transmitting buffer belongs to itself. If the stored data unit belongs to a specific hardware socket, at step 530, that hardware socket sets the value of the index bit corresponding to the first available transmitting buffer to zero (0). When the value of an index bit for a transmitting buffer is set to zero (0), the transmitting buffer is locked and no longer available for storing other data units to be transmitted later. At step 540, the stored data unit is transmitted out to the network through the hardware socket. When using TCP/IP protocol, TCP and IP headers are added to the information. At step 550, after the stored data unit is successfully transmitted out, the hardware socket sets the value of the corresponding index bit to one (1). When the value of an index bit is set to one (1), the corresponding buffer is released and is again available for storing other data units to be transmitted later. At step 560, if the stored information does not belong to any hardware socket, the value of the index bit corresponding to the first available transmitting buffer remains to be one (1). And the next coming data unit will be stored in the same buffer.

Although the invention has been described in terms of exemplary embodiments, it is not limited thereto. The described embodiment is to be considered in all respects only as illustrative and not as restrictive. The present invention may be embodied in other specific forms without departing from its essential characteristics. The scope of the invention, therefore, is indicated by the appended claims rather than by the foregoing description. All changes, which come within the meaning and range of the equivalents of the claims, are to be embraced within their scope.

We claim:

1. An apparatus for network communication comprising:
a plurality of buffers to store information received from and to be transmitted to a network, each buffer capable of storing one data unit transferred on the network; and
a plurality of hardware sockets capable of locking and releasing the buffers to allow buffer sharing;
wherein a number of the buffers is less than a number of the hardware sockets.

2. The apparatus of claim 1, wherein the hardware socket further comprises a comparator and an AND gate.

3. The apparatus of claim 1, wherein the buffer can store a packet of information for network communication through a transmission control protocol (TCP) and internet protocol (IP).

4. The apparatus of claim 3, wherein the packet has 1536 bytes.

5. The apparatus of claim 1, wherein the hardware sockets communicate with the network through a transmission control protocol (TCP) and internet protocol (IP).

6. The apparatus of claim 5, wherein the network can be internet or intranet.

7. The apparatus of claim 1, further comprises a control register to indicate an availability of the buffers.

8. The apparatus of claim 7, wherein the control register includes a plurality of index bits to index the availability of the buffers.

9. The apparatus of claim 8, wherein the index bit has a value of one (1) when the respective buffer is available and the index bit has a value of zero (0) when the respective buffer is not available.

10. The apparatus of claim 8, wherein the hardware socket sets the value of the index bit to lock the corresponding buffer which receives information for the hardware socket.

11. The apparatus of claim 8, wherein the hardware socket resets the value of the index bit to release the corresponding buffer when information stored in the buffer is processed.

12. The apparatus of claim 1 further comprising a CPU.

13. The apparatus of claim 12, wherein the CPU is an 8-bit CPU.

14. The apparatus of claim 1 further comprising a communication port.

15. An apparatus for intranet communication with a transmission control protocol/internet protocol (TCP/IP) comprising:
a plurality of buffers to store information received from and to be transmitted to a network, each buffer capable of storing one data unit transferred on the network;
a plurality of index bits to indicate an availability of the corresponding buffers; and
a plurality of hardware sockets capable of locking and releasing the buffers by setting a value of the index bits to allow buffer sharing;
wherein a number of the buffers is less than a number of the hardware sockets.

16. The apparatus of claim 15, wherein the hardware socket further comprises a comparator and an AND gate, and the buffer can store a data packet.

17. A method for network communication performed by an apparatus which includes a plurality of buffers, a plurality of index bits to indicate an availability of the corresponding buffers, and a plurality of hardware sockets capable of locking and releasing the buffers to allow buffer, comprising steps of:
storing a data unit in the available buffer;
checking whether the data unit belongs to the specific hardware socket;
setting the corresponding index bit to a first value if the data unit belongs to the specific hardware socket;
processing the stored data unit;
setting the corresponding index bit to a second value after the data unit is processed.

18. The method of claim 17, wherein processing the stored data unit is transferring the stored data unit received from the network to an destination.

19. The method of claim 17, wherein processing the stored data is sending the stored data unit to the network.

20. The method of claim 17, wherein the first value is zero (0) and the second value is one (1).
